(19) United States
(12) Patent Application Publication
(10) Pub. No.: US 2022/0395747 A1
(43) Pub. Date: Dec. 15, 2022

(54) DISPLAY DEVICE AND OPERATION METHOD THEREOF

(71) Applicants: MICRO-STAR INT'L CO.,LTD., New Taipei City (TW); MSI COMPUTER (SHENZHEN) CO., LTD., Shenzhen City (CN)

(72) Inventors: Chun-Te YEH, New Taipei City (TW); Chia-Fu LIU, New Taipei City (TW); Chung-Wen CHEN, New Taipei City (TW)

(73) Assignees: MICRO-STAR INT'L CO.,LTD., New Taipei City (TW); MSI COMPUTER (SHENZHEN) CO.,LTD., Shenzhen City (CN)

(21) Appl. No.: 17/496,085

(22) Filed: Oct. 7, 2021

(30) Foreign Application Priority Data
Jun. 11, 2021 (TW) 110206835

(51) Int. Cl. A63F 13/23; A63F 13/22

(52) U.S. Cl. CPC A63F 13/23; A63F 13/22; A63F 2300/1025

(57) ABSTRACT

A display device electrically connectable to an external operation device and a host is provided. The display device includes an imaging unit, a display controller, an image receiving port, a command output port and at least one computing device. The image receiving port obtains image data from the host and transmit to the display controller. The display controller controls the imaging unit to display the image data. The at least one computing device has a host operation mode and a display operation mode. The computing device receives a control command from the external operation device, sends the control command to the host through the command output port in the host operation mode, and sends the control command to the display controller to adjust the display setting in the display operation mode.

### CROSS-REFERENCE TO RELATED APPLICATIONS

This non-provisional application claims priority under 35 U.S.C. § 119(a) on Patent Application No(s). 110206835 filed in Taiwan, ROC on Jun. 11, 2021, and the entire contents of which are hereby incorporated by reference.

### BACKGROUND

### 1. Technical Field

The present disclosure relates to a display device and its operation method, and more particularly, to a display device configured to adjust its display settings by an external operation device, and the operation method thereof.

### 2. Related Art

A general display device used at home is often connected with different external host devices to display different images. For example, the display device may be connected with a commercially available game console to display game images, or connected with a computer host to display the operation interface of the operating system. Due to the rapid changes in technology, users' needs for screen display settings are becoming more and more diverse under different external host environments, such as matching various screen display brightness, contrast and surrounding sound to achieve an immersive gaming experience.

However, for example, in the case where the display is connected to the game console, whenever the user needs to change the display settings halfway through the game, he or she often needs to put down the game joystick, move the body forward to the display, and press the touch button installed at the bottom of the display to adjust the parameters of the display. This causes inconvenience to the user and affects the gaming experience and reduces the excitement of playing.

### SUMMARY

Accordingly, the present disclosure provides a display device and its operation method to satisfy the above requirements.

According to an embodiment of the present disclosure, a display device electrically connectable to an external operation device and a host is provided. The display device comprises an imaging unit, a display controller, an image receiving port, a command output port, and at least one computing device, in which the display controller electrically connects to the imaging unit; the image receiving port electrically connects to the display controller, in which the image receiving port is configured to obtain image data from the host and transmit the image data to the display controller, and the display controller controls the imaging unit to display the image data according to a display setting; the command output port is configured to electrically connect to the host; and said at least one computing device electrically connects to the display controller and the command output port, in which said at least one computing device has a host operation mode and a display operation mode, said at least one computing device is configured to receive a control command from the external operation device, said at least one computing device sends the control command to the host through the command output port in the host operation mode, and said at least one computing device sends the control command to the display controller to adjust the display setting in the display operation mode.

According to an embodiment of the present disclosure, a display device operation method comprises: receiving, by at least one computing device, a control command from an external operation device; sending, by said at least one computing device, the control command to a host through a command output port when said at least one computing device is in a host operation mode; sending, by said at least one computing device, the control command to a display controller to adjust a display setting when said at least one computing device is in a display operation mode; obtaining, by an image receiving port, image data from the host and transmitting the image data to the display controller; and controlling, by the display controller, an imaging unit to display the image data according to the display setting.

### BRIEF DESCRIPTION OF THE DRAWINGS

The accompanied drawings can help understand the present disclosure, which are provided out of illustrative purposes rather than limitations of the scope of the present disclosure, in which:

FIG. 1 is a block diagram of a display device according to an embodiment of the present disclosure;

FIG. 2 is a block diagram of the display device according to another embodiment of the present disclosure;

FIG. 3 is a flowchart of switching between modes of the computing device;

FIG. 4A and FIG. 4B are flowcharts of the computing device sending the control command according to the current mode

FIG. 5A is a schematic diagram of the image data displayed by the imaging unit when the computing device is in the host operation mode; and

FIG. 5B is a schematic diagram of the image data displayed by the imaging unit when the computing device is in the display operation mode.

### DETAILED DESCRIPTION

The detailed features and advantages of the invention are described in detail in the following detailed description, which is sufficient to enable anyone skilled in the art to understand the technical contents of the present disclosure and to implement it accordingly. In addition, according to the disclosed specification, claims and drawings, anyone skilled in the art may easily understand the purpose and advantages of the present disclosure. The following embodiments are intended to illustrate the points of view of the invention in further detail, rather than limiting the scope of the present disclosure in any kind of manner.

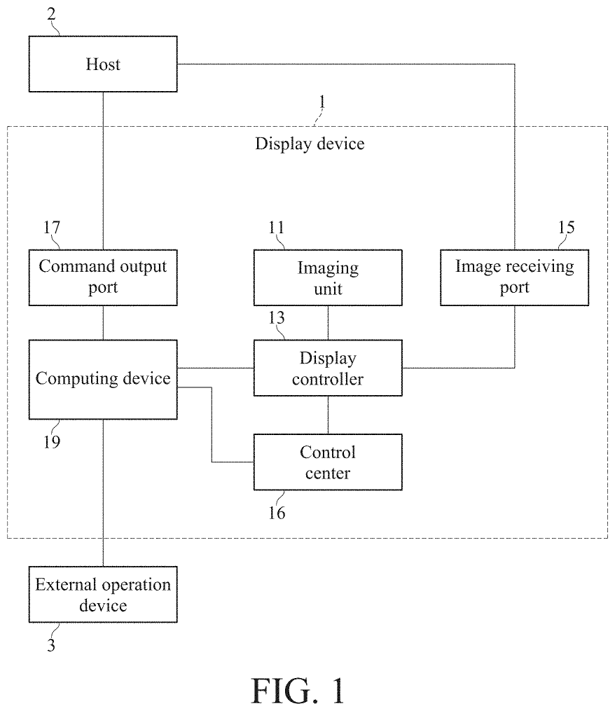

Please refer to FIG. 1. FIG. 1 is a block diagram of a display device according to an embodiment of the present disclosure. The display device 1 in this embodiment of the present disclosure is suitable for electrically connecting to a host 2 and an external operation device 3. The host 2 may be, for example, a commercially available game console, and the external operation device 3 may be, for example, a remote control joystick corresponding to the commercially available game console.

The display device 1 includes an imaging unit 11, a display controller 13, an image receiving port 15, a command output port 17 and at least one computing device 19.

The imaging unit 11 may be, for example, a liquid crystal-display (LCD) or another kind of display with similar specification or functions, but the present disclosure is not limited thereto.

The display controller 13 is electrically connected to the imaging unit 11, the display controller 13 may be, for example, a scaler or another kind of controller with similar specification or functions, but the present disclosure is not limited thereto.

The image receiving port 15 is electrically connected to the controller 13, the image receiving port 15 is configured to obtain image data from the host 2 and transmit the image data to the display controller 13. The display controller 13 controls the imaging unit 11 to display the image data according to a display setting. The image receiving port 15 may be, for example, a High Definition Multimedia Interface (HDMI), a personal computer DisplayPort (PC DP), or another kind of receiving port with similar specification or functions, but the present disclosure is not limited thereto.

The command output port 17 is electrically connected to the host 2, and the command output port 17 may be, for example, a universal serial bus (USB) connecter, or another kind of connecter with similar specification or functions, but the present disclosure is not limited thereto.

The at least one computing device 19 is electrically connected to the display controller 13 and the command output port 17. In one example, there is only one computing device 19 electrically connected to the external operation device 3, and the electrical connection between the computing device 19 and the external operation device 3 can be wired or wireless.

The at least one computing device 19 has a host operation mode and a display operation mode, the at least one computing device 19 is configured to receive a control command from the external operation device 3, the at least one computing device 19 sends the control command to the host 2 through the command output port 17 in the host operation mode, the at least one computing device 19 sends the control command to the display controller 13 to adjust the display settings in the display operation mode. The at least one computing device 19 is configured to receive a switching command from the external operation device 3, the at least one computing device 19 switches between the host operation mode and the display operation mode according to the switching command.

Please refer to FIG. 1. The display device 1 of an embodiment of the present disclosure further includes a control center 16, and the control center 16 is electrically connected to the display controller 13. The control center 16 can drive the computing device 19 to update the firmware thereof through the electrical connection with the computing device 19. The operation protocols of more brands and models of the external operation devices 3 can be installed to the computing device 19 through the firmware update, and thus the computing device 19 may support and determine more brands and models of the external operation device 3 via the operation protocols. For example, before leaving the factory, the display device 1 is only installed with and supports the operation protocol of the external operation device 3 when the external operation device 3 is a joystick of an Xbox One game console produced by Microsoft. However, the protocol firmware of the Xbox One joysticks can be updated to have data of the Play Station game console produced by the Japanese company Sony installed into the computing device 19. Hence, when the display device 1 is electrically connected to a Sony PS4 game console, the plugged-in game console (i.e. the external operation device 3) can be used to perform desired operations on the Sony PS4 game console.

In some other embodiments of the present disclosure, the display device 1 may omit the design of the control center 16.

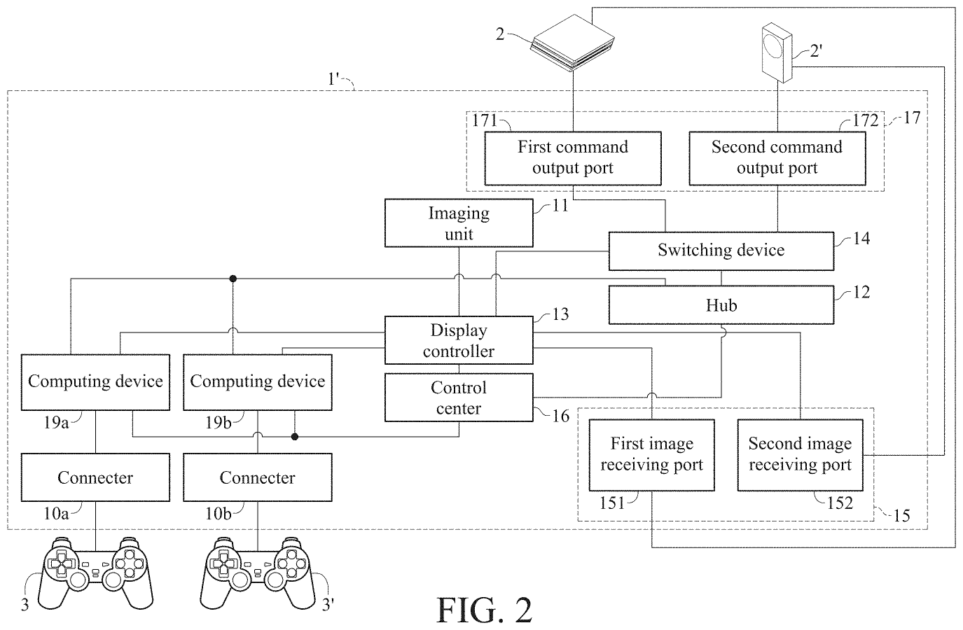

Please refer to FIG. 2, which illustrates a block diagram of the display device according to another embodiment of the present disclosure. In this embodiment, the at least one computing device has a plurality of computing devices. It should be noted that the number of computing devices shown in FIG. 2 is merely an example, and the present disclosure is not limited thereto. As shown in FIG. 2, the display device 1′ is electrically connectable to an external operation device 3, an external operation device 3′, a host 2, and a host 2′.

The display device 1′ includes an imaging unit 11, a display controller 13, a hub, 12, a switching device 14, an image receiving port 15, a command output port 17, a computing device 19a, a computing device 19b, a connecter 10a, a connecter 10b, and a control center 16.

The imaging unit 11 may be, for example, an LCD or another kind of display with similar specification or functions, but the present disclosure is not limited thereto.

The display controller 13 is electrically connected to the imaging unit 11. The display controller 13 may be, for example, a scaler or another kind of controller with similar specification or functions, but the present disclosure is not limited thereto.

The image receiving port 15 includes a first image receiving port 151 and a second image receiving port 152. The first image receiving port 151 and the second image receiving port 152 electrically connect to the display controller 13, in which the first image receiving port 151 is electrically connected to the host 2 and the second image receiving port 152 is electrically connected to the host 2′. The first image receiving port 151 is configured to obtain image data from the host 2 and transmit the image data to the display controller 13, and the second image receiving port 152 is configured to obtain the image data from the host 2′ and transmit the image data to the display controller 13. The display controller 13 controls the imaging unit 11 to display the image data according to the display settings. The first image receiving port 151 and the second image receiving port 152 may be, for example, High Definition Multimedia Interfaces (HDMI), personal computer Display Ports (PC DP), or another kind of receiving ports with similar specification or functions, but the present disclosure is not limited thereto.

The control center 16 is electrically connected to the display controller 13, the control center 16 may be, for example, a micro control unit (MCU), or another kind of controller with similar specification or functions, but the present disclosure is not limited thereto.

The computing device 19a and the computing device 19b electrically connect to the display controller 13. The computing device 19a and the computing device 19b may be, for example, MCUs, or another kind of controller with similar specification or functions, but the present disclosure is not limited thereto.

The hub 12 is electrically connected to the computing device 19a and the computing device 19b. The hub 12 may be, for example, a USB hub, or another kind of hub with similar specification or functions, but the present disclosure is not limited thereto.

The control center 16 is electrically connected to the computing device 19a and the computing device 19b through the hub 12.

The control center 16 stores a software, and the control center 16 drives one of the computing device 19a and computing device 19b to update firmware via the software.

The switching device 14 is electrically connected to the hub 12 and the command output port 17. The switching device 14 may be, for example, a USB switch. The switching device 14 switches to the corresponding USB signal source according to the source of display signal, such as the USB signal source of the host 2 or the host 2′.

The command output port 17 includes a first command output port 171 and the second command output port 172. The first command output port 171 is electrically connected to the switching device 14 and the host 2, and the second command output port 172 is electrically connected to the switching device 14 and the host 2′. The command output port 17 may be, for example, a USB output connecter, or another kind of connecter with similar specification or functions, but the present disclosure is not limited thereto.

Depending on whether the image data is sent from the host 2 through the first image receiving port 151 or from the host 2′ through the second image receiving port 152, the display controller 13 sends the control command to control the switching device 14 to switch to the signal source of the host 2 or the host 2′. Depending on the switching operation of the switching device 14, the computing device 19a and the computing device 19b is electrically connected to one of the first command output port 171 and the second command output port 172 through the hub 12 and the switching device 14.

In other words, when the image data received by the display controller 13 is sent from the host 2 through the first image receiving port 151, the display controller 13 controls the switching device 14 to switch to the first command output port 171 so that the computing device 19a and the computing device 19b may electrically connect to the first command output port 171 through the hub 12 and the switching device 14. When the image data received by the display controller 13 is sent from the host 2′ through the second image receiving port 152, the display controller 13 controls the switching device 14 to switch to the second command output port 172 so that the computing device 19a and the computing device 19b may electrically connect to the second command output port 172 through the hub 12 and the switching device 14.

The connecter 10a is electrically connected to the computing device 19a and the external operation device 3, in other words, the computing device 19a is electrically connected to the external operation device 3 through the connecter 10a in a wired manner. The connecter 10b is electrically connected to the computing device 19b and the external operation device 3′, in other words, the computing device 19b is electrically connected to the external operation device 3′ through the connecter 10b in a wired manner.

The connecter 10a and the connecter 10b may be, for example, USB dongles, or another kind of connecter with similar specification or functions, but the present disclosure is not limited thereto.

The computing device 19a is electrically connected to the display controller 13, and is electrically connected to the first command output port 171 and the second command output port 172 through the hub 12 and the switching device 14. In addition, the computing device 19a has a host operation mode and a display operation mode, and the computing device 19a is configured to receive the control command from the external operation device 3. In the host operation mode, the computing device 19a sends the control command to the host 2 through the first command output port 171 or to the host 2′ through the second command port 172. In the display operation mode, the computing device 19a sends the control command to the display controller 13 to adjust the display settings.

The computing device 19b is electrically connected to the display controller 13, and is electrically connected to the first command output port 171 and the second command output port 172 through the hub 12 and the switching device 14. The computing device 19b has a host operation mode and a display operation mode, and the computing device 19b is configured to receive the control command from the external operation device 3′. In the host operation mode, the computing device 19b sends the control command to the host 2 through the first command output port 171 or to the host 2′ through the second command port 172. In the display operation mode, the computing device 19b sends the control command to the display controller 13 to adjust the display settings.

The computing device 19a and the computing device 19b shown in the embodiment of FIG. 2 may support and determine external operation devices of more brands and models, such as the external operation device 3 and the external operation device 3′, by updating the firmware.

The present disclosure provides an operation method of the display device such as the display device shown in FIG. 1 and the operation method includes: receiving, by at least one computing device 19, a control command from an external operation device 3; sending, by the at least one computing device 19, the control command to a host 2 through a command output port 17 when the at least one computing device 19 is in a host operation mode; sending, by the at least one computing device 19, the control command to a display controller 13 to adjust a display setting when the at least one computing device 19 is in a display operation mode; obtaining, by an image receiving port 15, image data from the host 2 and transmitting the image data to the display controller 13; and controlling, by the display controller 13 an imaging unit 11 to display the image data according to the display settings. The operation method of display device 1 according to the above embodiment further includes: receiving, by the at least one computing device 19, the control command from the external operation device 3; and switching, by the at least one computing device 19, between the host operation mode and the display operation mode according to the switching command.

The operation method of the display device 1 shown in FIG. 1 is also applicable to the display device 1′ shown in FIG. 2, and the description is omitted here for brevity since the concept is similar.

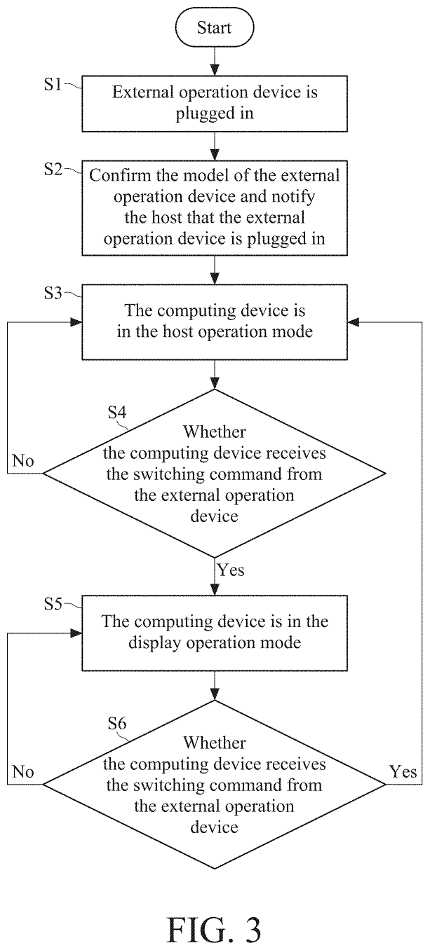

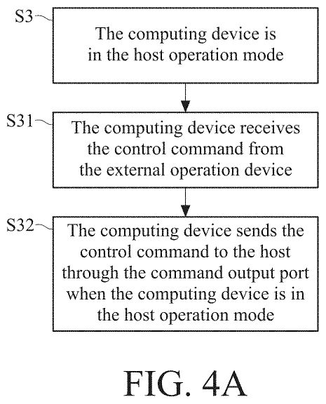

The implementation of the operation method of the display device 1 is specifically shown in FIG. 3, FIG. 4A, and FIG. 4B, in which FIG. 3 is a flowchart of switching between modes of the computing device, and FIG. 4A and FIG. 4B are flowcharts of the computing device sending the control command according to the current mode.

Please refer to FIG. 1 and FIG. 3. The display device 1 is in the stage “Start” as shown in FIG. 3. The image receiving port 15 is electrically connected to the host 2, in which the host 2 may be, for example, a commercially available game console such as PS4, PS5, Xbox One or Nintendo Switch. In step S1, the external operation device 3 is plugged in. Since the external operation device 3 is plugged into the input socket through the plug of wire, and the socket corresponds to the computing unit 19 of the display device 1, the display device 1 is therefore electrically connected to the external operation device 3. The external operation device 3 may be, for example, joysticks of commercially available game consoles of various brands. In step S2, the model of the external operation device 3 is confirmed and the host 2 is notified that the external operation device 3 is plugged in. Since the computing device 19 stores protocols corresponding to the external operation devices of various brands and models, the display device 1 may support the external operation device 3 of various brands and models to inform the host 2 of that a corresponding external operation device 3 is plugged into the display device 1, in order to facilitate the host 2 to operate corresponding to the external operation device 3.

In step S3, the computing device 19 is in the host operation mode. When the computing device 19 successfully determines the model of the external operation device 3, the computing device 19 will enter the host operation mode by default. In step S4, whether the computing device 19 receives the switching command from the external operation device 3 is determined. After the computing device 19 enters the host operation mode by default, if the computing device 19 receives the switching command from the external operation device 3 again, the computing device 19 may exit from the host operation mode and switch to the display operation mode. Otherwise, if the computing device 19 does not receive the switching command from the external operation device 3, the computing device 19 is still in the host operation mode.

In step S5, the computing device 19 is in the display operation mode. When the computing device 19 is in the host operation mode and receives the switching command from the external operation device 3, the computing device 19 will switch from the host operation mode to the display operation mode. In step S6, whether the computing device 19 receives the switching command from the external operation device 3 is determined. When the computing device 19 is in the display operation mode and receives the control command from the external operation device 3, the computing device 19 will switch from the display operation mode to the host operation mode. Otherwise, if the computing device 19 is in the display operation mode and does not receive the switching command from the external operation device 3, the computing device 19 is still in the display operation mode.

The implementation of the operation method of the display device 1 shown in FIG. 1 can be also applied to the display device 1′ shown in FIG. 2. Since the concept would be similar, further description is omitted here for brevity.

Please refer to FIG. 1, FIG. 4A, and FIG. 4B. FIG. 4A is a flowchart of the computing device sending the control command when the computing device is in the host operation mode according to an embodiment of the present disclosure, FIG. 4B is a flowchart of the computing device sending the control command when the computing device is in the display operation mode according to an embodiment of the present disclosure. As shown in FIG. 4A, in step S31, the computing device 19 receives the control command of the external operation device 3. In step S32, the computing device 19 sends the control command to the host 2 through the command output port 17 when the computing device 19 is in the host operation mode.

When the computing device 19 is in the host operation mode, the computing device 19 will send the control command received from the external operation device 3 to the host 2, and the external operation device 3 directly controls the operations of the host 2 during sending the control command.

As shown in FIG. 4B, in step S52, the computing device 19 sends the control command to the display controller 13 to adjust the display settings when the computing device 19 is in the display operation mode; in step S53, the image receiving port 15 obtains the image data from the host 2 and transmits the image data to the display controller 13; and in step S54, the display controller 13 controls the imaging unit 11 to display the image data according to the display settings.

When the computing device 19 is in the display operation mode, the computing device 19 will send the control command to the display controller 13, and the external operation device 3 controls, according to the display settings, the imaging unit 11 to display the image data which is sent to the display device 1 from the host 2. It should be noted that the order of step S52 and step S53 can be exchanged, but the present disclosure is not limited thereto.

The flowcharts of FIG. 4A and FIG. 4B are also applicable to the display device 1′ shown in FIG. 2, and the description is omitted here for brevity since the concept is similar.

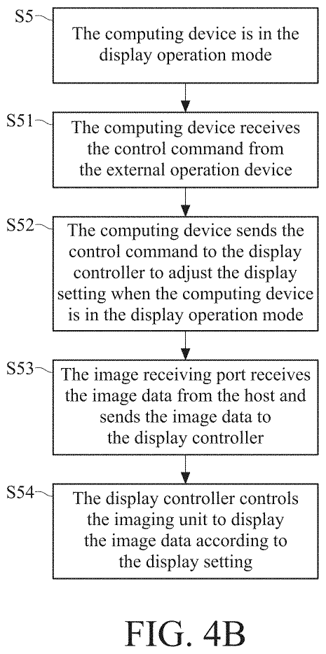

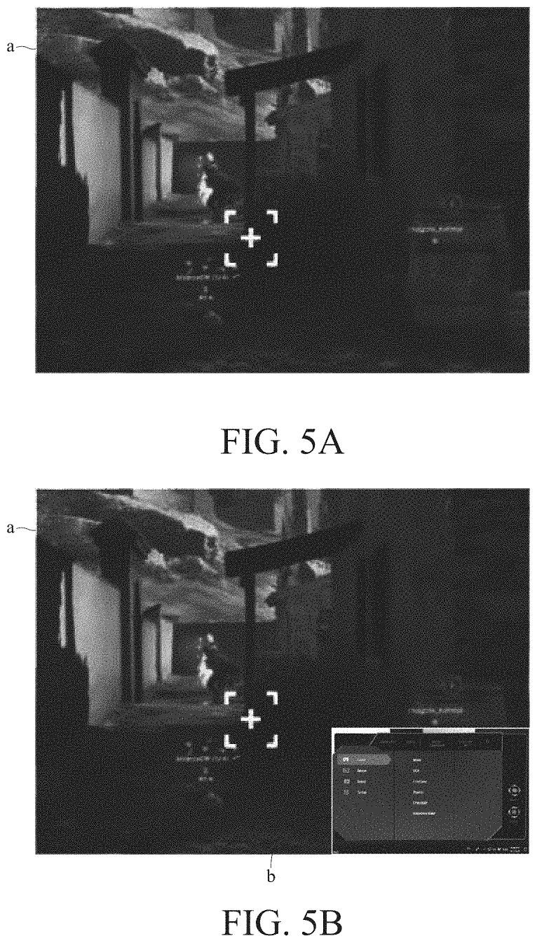

Please refer to FIG. 2, FIG. 5A and FIG. 5B. FIG. 5A is a schematic diagram of the image data displayed by the imaging unit when the computing device is in the host operation mode, and FIG. 5B is a schematic diagram of the image data displayed by the imaging unit when the computing device is in the display operation mode. For example, the external operation device 3 and the external operation device 3′ may be a game joystick of the same brand and model (such as Sony PS4), while the host 2 and the host 2′ may be game consoles of different brands. The external operation device 3 is electrically connected to the computing device 19a included in the display device 1 in a wired manner by the connecter 10a, and the external operation device 3′ is electrically connected to the computing device 19b included in the display device 1 in a wired manner by the connecter 10b. When the external operation device 3 and the external operation device 3′ are plugged in, the computing device 19a and the computing device 19b are in the host operation mode by default. By pressing a preset key combination of the external operation device 3, such as pressing key “LT”, key “LB” and key “Up”, the external operation device 3 will send the switch command to the computing device 19a, thus commanding the computing device 19a to switch between the host operation mode and the display operation mode. Similarly, by pressing a preset key combination of the external operation device 3′, such as pressing keys “LT”, “LB” and “Up”, the external operation device 3′ will send the switch command to the computing device 19b, thus commanding the computing device 19b to switch between the host operation mode and the display operation mode.

If the user selects the host 2 for playing game and powers on the host 2, the host 2 transmits the current image data “a” to the display controller 13 through the first image receiving port 151, the display controller 13 confirms that the source of the current image data “a” is the first image receiving port 151 and controls the switching device 14 to switch so that the computing device 19a and the computing device 19b are electrically connected to the first command output port 171 through the hub 12 and the switching device 14.

When the computing device 19a is in the host operation mode, the external operation device 3 directly controls the host 2 to initiate the game by sending the control command. When the computing device 19b is in the host operation mode, the external operation device 3′ directly controls the host 2 to initiate the game by sending the control command. The host 2 transmits the current image data “a” to the display device 1 through the first image receiving port 151, and the display device 1 controls the imaging unit 11 to display the image data “a” as shown in FIG. 5A. When there is a need for adjusting the display settings during the game, the user can press the keys “LT”, “KB” and “Up” simultaneously to switch the computing device 19a and the computing device 19b into the display operation mode, and the imaging unit 11 corresponding to the lower right corner of the image data “a” shows the display setting menu “b”, as shown in FIG. 5B. The user may send the control command by the computing device 19a or the computing device 19b, in order to perform operations on the display controller 13 and make the imaging unit 11 generate the operation result. In other words, the user may operate the display setting menu “b” at the lower right corner of the image data by the game joystick and immediately adjust parameters of the image data, such as the brightness or the contrast, without moving his/her body forward to the display device and then pressing the touch buttons, in which these buttons disposed on the display device 1 are configured to adjust the display settings. The user may use the game joystick in his/her hand to directly adjust the display settings.

As mentioned above, after the user adjust the display settings, he or she may press the preset key combination, such as the key “LT”, the key “LB, and the key “Up” for switching the computing device 19a or the computing device 19b into the host operation mode to facilitate the subsequence process of the game. After the user adjusts the display settings with the display setting menu “b”, except for pressing the preset key combination of switching mode, the user can also select the “Exit” option in the display setting menu “b” to close the display setting menu “b” at the lower right corner of the image data, and the computing device 19a or the computing device 19b may return to the host operation mode. In other words, the user may switch the computing device 19a or the computing device 19b from the display operation mode into the host operation mode by selecting the “Exit” option in the display setting menu “b”.

In view of the above description, the present disclosure proposes a display device and a display device operation method. Since said at least one computing device may switch between the host operation mode and the display operation mode, when said at least one computing device is in the display operation mode, said at least one computing device sends the control command, which is received from the external operation device, to the display controller for directly adjusting the setting of the display screen, in this case, the user can maintain the distance between the user and the display device, and directly use the external operation device to set the parameters of the display screen without moving his/her body forward to the display device, thus improving the user experience and providing the user with real-time interaction with the display device.

Although the present disclosure is disclosed in the above embodiments, those are not intended to limit the present disclosure. All changes and modifications made without departing from the spirit and scope of the present disclosure shall fall within the scope of the present disclosure. The claimed scope of the present disclosure can be referred to the attached claims.

What is claimed is:

1. A display device electrically connectable to an external operation device and a host, comprising:
an imaging unit;
a display controller electrically connecting to the imaging unit;
an image receiving port electrically connecting to the display controller, wherein the image receiving port is configured to obtain image data from the host and transmit the image data to the display controller, and the display controller controls the imaging unit to display the image data according to a display setting;
a command output port configured to electrically connect to the host; and
at least one computing device electrically connecting to the display controller and the command output port, wherein said at least one computing device has a host operation mode and a display operation mode, said at least one computing device is configured to receive a control command from the external operation device, said at least one computing device sends the control command to the host through the command output port in the host operation mode, and said at least one computing device sends the control command to the display controller to adjust the display setting in the display operation mode.

2. The display device of claim 1, wherein said at least one computing device is configured to receive a switching command from the external operation device, and said at least one computing device switches between the host operation mode and the display operation mode according to the switching command.

3. The display device of claim 1, wherein said at least one computing device has a plurality of computing devices.

4. The display device of claim 3, further comprising a hub and a control center, wherein the hub is electrically connected to the plurality of computing devices, the control center is electrically connected to the display controller, the control center is electrically connected to the plurality of computing devices through the hub, the plurality of computing devices electrically connect to the command output port through the hub, the control center stores software and drives one of the plurality of the computing devices to update firmware according to the software.

5. The display device of claim 1, further comprising a control center electrically connecting to said at least one computing device and the display controller, wherein the control center drives one of the plurality of the computing devices to update firmware.

6. A display device operation method, comprising:
receiving, by at least one computing device, a control command from an external operation device;
sending, by said at least one computing device, the control command to a host through a command output port when said at least one computing device is in a host operation mode;
sending, by said at least one computing device, the control command to a display controller to adjust a display setting when said at least one computing device is in a display operation mode;
obtaining, by an image receiving port, image data from the host and transmitting the image data to the display controller; and
controlling, by the display controller, an imaging unit to display the image data according to the display setting.

7. The display device operation method of claim 6, further comprising:
receiving, by said at least one computing device, a switching command from the external operation device; and
switching, by said at least one computing device, between the host operation mode and the display operation mode according to the switching command.

8. The display device operation method of claim 6, wherein said at least one computing device has a plurality of computing devices, and before receiving, by the plurality of computing devices, the control command from the external operation device, the display device operation method further comprises:
driving, by a control center, one of the plurality of the computing devices to update firmware according to software.

9. The display device operation method of claim 6, wherein before receiving, by the plurality of computing devices, the control command from the external operation device, the display device operation method further comprises:
driving, by a control center, said at least one computing device to update firmware.

10. The display device operation method of claim 6, wherein the image receiving port comprises a first image receiving port and a second image receiving port, the command output port comprises a first command output port and a second command output port, said at least one computing device has a plurality of computing devices, before receiving, by said at least one computing devices, the control command from the external operation device, the display device operation method further comprises:
controlling, by the display controller, a switching device to perform a switch operation according to whether a source of the image data is the first image receiving port or a second image receiving port; and
electrically connecting the plurality of computing devices to one of the first command output port and the second command output port through a hub and the switching device according to the switching operation.
